(19) United States
(12) Patent Application Publication
(10) Pub. No.: US 2024/0157364 A1
(43) Pub. Date: May 16, 2024

(54) APPARATUS FOR DETECTING TARGET ANALYTE

(71) Applicant: SEEGENE, INC., Seoul (KR)

(72) Inventors: Ariel KULE, Woburn, MA (US); Luke HAGAN, Seattle, WA (US); Zachary GEHRKEN, Providence, RI (US)

(73) Assignee: SEEGENE, INC., Seoul (KR)

(21) Appl. No.: 17/985,412

(22) Filed: Nov. 11, 2022

(51) Int. Cl. B01L 3/00; B01L 7/00

(52) U.S. Cl. CPC B01L 3/5085; B01L 7/52; B01L 2300/0654; B01L 2300/1805; B01L 2300/1894

(57) ABSTRACT

An apparatus for detecting a target analyte according to the present disclosure includes: a light detection module that irradiates light to a reaction vessel and detects signals; a thermal module for heating and cooling the reaction vessel; and a lifting device for vertically moving the thermal module.

### TECHNICAL FIELD

The present disclosure relates to an apparatus for detecting a target analyte.

### BACKGROUND ART

Recently, people's interest in health have been growing along with prolonged human life expectancy. Thus, the importance of accurate analysis of pathogens and in vitro nucleic acid-based molecular diagnosis such as genetic analysis for a patient has increased significantly, and the demand therefor is on the rise.

Generally, nucleic acid-based molecular diagnosis is performed by extracting nucleic acids from a sample and confirming whether a target nucleic acid is present in the extracted nucleic acids.

The most widely used nucleic acid amplification reaction, which is well-known as a Polymerase Chain Reaction (PCR), repeats a cyclic process which includes denaturation of a double-stranded DNA, annealing of an oligonucleotide primer with a denatured DNA template, and extension of the primer by a DNA polymerase (Mullis et al.; U.S. Pat. Nos. 4,683,195, 4,683,202 and 4,800,159; Saiki et al., (1985) Science 230, 1350-1354).

Recently, various nucleic acid amplification apparatuses have been developed for performing a nucleic acid amplification reaction. An example of a nucleic acid amplification apparatus is configured to mount a vessel containing a sample solution including a template nucleic acid in one reaction chamber, and to perform a nucleic acid amplification reaction by repeatedly heating and cooling the vessel.

In order to amplify a deoxyribonucleic acid (DNA) having a specific nucleotide sequence, the apparatus for a nucleic acid amplification reaction may perform a denaturing step, an annealing step, and an extension (or amplification) step.

The DNA denaturation is performed at about 95° C., and the annealing and extension of primers are performed at a temperature of 55° C. to 75° C. which is lower than 95° C. Therefore, the reaction vessels or chambers containing samples are heated and then cooled repeatedly in order to perform a nucleic acid amplification reaction.

In order to perform a nucleic acid amplification reaction on a plurality of samples, a thermal block having a plurality of sample wells is used in some cases. A reaction vessel for accommodating the samples is inserted in the plurality of sample wells. That is, by inserting the reaction vessel into the sample wells of the thermal block, and heating or cooling the thermal block using, for example, a Peltier element, the nucleic acid amplification reaction of each sample is performed simultaneously. At this time, a heated lid may be used to prevent evaporation or condensation of the samples, by heating the reaction vessel. Here, the reaction vessel may be a multi-well sample plate.

In general, from a top view, the sample wells of the thermal block are arranged in rows and columns, in the form of 4×4 for 16 wells, 4×8 for 32 wells, 8×8 for 64 wells, 8×12 for 96 wells, and largely by 16×24 for 364 wells.

The thermal block, also referred to as a heating block, is usually fabricated of a metal for rapid heat conduction. A user loads a reaction vessel, for example, a 96-well sample plate onto the thermal block for thermal cycling and analysis. Then, in order to detect a target analyte in the samples, an optic module having a light source and the optic module is positioned over the sample plate and the sample plate is clamped between the thermal block and a heated lid.

The alignment of the optical module relative to the sample plate is critical for system performance. Conventionally, the heated lid would be attached to the bottom surface of a movable cover such that the heated lid would be clamped down on the sample plate as the cover is lowered from above the sample plate. Here, the alignment of the heated lid and the optical module plays a significant role in precise irradiation and detection of light signals to and from the sample plate. Generally, the light source of the optical module that provides excitation light to the samples in the sample plate, as well as the detector of the optical module that detects emission light from the samples, would be installed and positioned over the heated lid. Preferably, the heated lid may have holes that correspond to the sample wells of the sample plate, to allow optical communication between the sample wells and the optical module.

Accordingly, it is important to position the sample plate, the heated lid and the optical module to be properly aligned with respect to each other. In the prior arts, in order to set a light source and detector of an optical module over a sample plate, the light source and detector would be moved vertically and/or horizontally. However, with continuous use, the light source and detector would naturally be exposed to impact, vibration and misalignment. Such impact can lead to shortened product life and inconsistent, unreliable detection results.

Therefore, there is a need for an apparatus for detecting target analytes configured such that the movement of the optical module is minimized, as well as enabling the optical module and the sample plate to be precisely aligned consistently.

Additionally, clamping force may also affect the ramp rate of the thermal module, and clamping uniformity is known to influence system efficacy. More specifically, when the sample plate is inserted into the wells of the thermal block, and the nucleic acid amplification reaction of each sample is performed simultaneously. At this time, it is important to perform temperature control of all samples uniformly.

However, when comparing the central portion of the thermal block with the rest of the outer edge portion of the thermal block, the heat capacity of the central portion is greater than that of the outer edge portion. Accordingly, there is a structural limitation that the temperature of the central portion rises later than the outer edge portion when heating the thermal block, and the temperature of the central portion decreases later than the outer edge portion when cooling the thermal block.

For this reason, it is difficult to uniformly control the temperature of the samples located near the central portion and the samples near the outer edge portion. The difference in the temperature range maintained between the samples gets larger as the response delay increases due to the temperature change in the central portion. As a result, the performance of the apparatus for performing the nucleic acid amplification reaction is degraded. In particular, this problem increases as the size of the thermal block increases.

The PCR reaction is a reaction amplifying a target nucleic acid by repeating steps of hybridizing a specific primer to a target nucleic acid sequence, extending it by a polymerase, and subsequently separating extended strands. In a PCR reaction, this series of steps is performed efficiently by maintaining the reaction mixture at each designated temperature for set periods of time. Thus, it is very important to maintain accurate temperatures for each step in the PCR reaction because the amplification efficiency in each cycle may decrease when the accurate temperature is not maintained for each step.

In particular, when the same test is performed on a plurality of samples using the PCR reaction, temperature deviation which continuously occurs among the wells may cause the amplification reaction to proceed with different efficiencies for each of the plurality of samples subjected to the amplification reaction in different wells. Since the PCR reaction repeats tens of cycles of nucleic acid amplification, and a DNA strand generated in a cycle serves as a DNA template in the subsequent cycle, the difference in amplification efficiency occurring in each cycle may greatly affect the analysis result.

Accordingly, there has been a demand for the development of an apparatus for detecting a target analyte capable of increasing the efficiency of the nucleic acid amplification reaction and the performance of the apparatus by uniformly controlling the temperature while minimizing the temperature difference between the samples, in particular, the temperature difference between the central portion and the outer edge portion of the thermal block.

### PRIOR ART DOCUMENT

### Patent Document

(Patent document 1) U.S. Pat. No. 8,236,504 (Aug. 7, 2012)

### SUMMARY OF INVENTION

### Technical Task

In consideration of the above-described background, the present disclosure is directed to provide an apparatus for detecting a target analyte that is capable of minimizing movement of the optical module and improving uniform temperature control.

The technical tasks to be solved by the present disclosure are not limited to the aforementioned technical task.

### Means for Solving the Task

According to one aspect of the present disclosure, the present disclosure may provide an apparatus for detecting a target analyte including: a light detection module that irradiates light to a reaction vessel and detects signals; a thermal module for heating and cooling the reaction vessel; and a lifting device for vertically moving the thermal module.

Further, the lifting device may include a height adjusting device for supporting the thermal module, and a motor for providing a driving force to the height adjusting device.

Further, the height adjusting device may include a platform which forms an upper surface of the height adjusting device, and a plurality of compliant bumpers mounted on the platform.

Further, the compliant bumpers each include a conical portion with a curved sidewall, and the conical portion is at least partially formed of an elastic material.

Further, the compliant bumpers may each be mounted and disposed to be spaced apart from each corner of the platform by a predetermined distance.

Further, the height adjusting device may use a scissor lift mechanism to vertically move the platform.

Further, the height adjusting device may include a rotating shaft, and the rotating shaft is coupled to the motor and rotated by the motor.

Further, the apparatus may further include: a motor frame that encloses at least a portion of the motor, and a motor mount to which the motor frame is vertically slidably coupled.

Further, a heating plate may be provided on a lower portion of the light detection module.

Further, the reaction vessel may be seated on the thermal module, and when the thermal module is moved upward by the lifting device, the reaction vessel moves closer to the heating plate, and when the thermal module is moved downward by the lifting device, the reaction vessel moves away from the heating plate.

Further, when the thermal module moves downward, the light detection module and the thermal module may be movable away from each other in a horizontal direction.

Further, the light detection module may be mounted on a slidable upper frame and coupled to a linear motor, and the light detection module slides horizontally using the linear motor.

Further, the light detection module may include a filter wheel to which a plurality of optical fibers is coupled.

### Effect of Invention

According to an embodiment of the present disclosure, by providing a lifting device for vertically moving a thermal module, movement of the optical module can be minimized, which can improve product life as well as misalignment, for more reliable and consistent detection results.

Further, the position of the thermal module can be adjusted conveniently. In particular, the lifting device is used to level the thermal module against a heated lid, making it possible to perform uniform temperature control of a reaction vessel.

Thus, it is possible to increase the product life and reliability of the apparatus for detecting a target analyte by enabling consistent alignment and protecting the optical module from unnecessary impact and vibration. Also, it is possible to increase the efficiency of the nucleic acid amplification reaction and the performance of the apparatus by minimizing the difference between the temperature change rate and the temperature maintenance range between the samples.

### BRIEF DESCRIPTION OF DRAWINGS

FIG. 1 is a perspective view for describing an apparatus for detecting a target analyte, wherein a lifting device is in an elevated state, according to an embodiment of the present disclosure.

FIG. 2 is a perspective view for describing an apparatus for detecting a target analyte, wherein a lifting device is in a lowered state and a thermal module is in an open state, according to an embodiment of the present disclosure.

FIG. 3 is a perspective view illustrating a lifting device and a lower frame according to an embodiment of the present disclosure.

FIG. 4 is an exploded perspective view for describing a driving unit according to an embodiment of the present disclosure.

FIG. 5 is a side view for describing an apparatus for detecting a target analyte, wherein a lifting device is in an elevated state, according to an embodiment of the present disclosure.

FIG. 6 is a side view for describing an apparatus for detecting a target analyte, wherein a lifting device is in a lowered state and a thermal module is in a closed state, according to an embodiment of the present disclosure.

FIG. 7 is a side view for describing an apparatus for detecting a target analyte, wherein a lifting device is in a lowered state and a thermal module is in an open state, according to an embodiment of the present disclosure.

### DETAILED MEANS FOR CARRYING OUT THE INVENTION

Hereinafter, the present disclosure will be explained with reference to embodiments and example drawings. The embodiments are for illustrative purposes only, and it should be apparent to a person having ordinary knowledge in the art that the scope of the present disclosure is not limited to the embodiments.

In addition, in adding reference numerals to the components of each drawing, it should be noted that same reference numerals are assigned to same components as much as possible even though they are shown in different drawings. In addition, in describing the embodiments of the present disclosure, when it is determined that a detailed description of a related well-known configuration or function interferences with the understanding of the embodiments of the present disclosure, the detailed description thereof will be omitted.

In addition, in describing the components of the embodiments of the present disclosure, terms such as first, second, A, B, (a), (b), (i), (ii), etc. may be used. These terms are only for distinguishing the components from other components, and the nature or order of the components is not limited by the terms. When a component is described as being “connected,” “coupled” or “fastened” to other component, the component may be directly connected or fastened to the other component, but it will be understood that another component may be “connected,” “coupled” or “fastened” between the components.

As used herein, the term “sample heating apparatus” refers to an apparatus having a thermal block and a heating means, which can be used for controlling the temperature of the samples uniformly. As used herein, the term “sample” may include a biological sample (e.g., cells, tissues and fluids from a biological source) and a non-biological sample (e.g., food, water and soil). Examples of the biological sample may include viruses, bacteria, tissues, cells, blood (e.g., whole blood, plasma and serum), lymph, bone marrow fluid, salvia, sputum, swab, aspiration, milk, urine, feces, ocular fluid, semen, brain extract, spinal fluid, joint fluid, thymus fluid, bronchoalveolar lavage fluid, ascites and amniotic fluid. Also, the sample may include natural nucleic acid molecules isolated from a biological source and synthetic nucleic acid molecules. According to an embodiment of the present disclosure, the sample may include an additional substance such as water, deionized water, saline solution, pH buffer, acid solution or alkaline solution.

As used herein, the term “thermal module” may be used as a unit that includes a thermal block, a thermoelectric element such as a Peltier element, a heat sink, a heat dissipation fan, and other components needed for efficiently heating and cooling a reaction vessel for performing nucleic acid amplification reactions.

As used herein, the term “reaction vessel” refers to a unit capable of containing a reactant (e.g., a reaction solution or reaction mixture). A test tube, a PCR tube, a strip tube, a vial, a multi-well PCR plate, a microtiter plate, a capillary tube, are all examples of a reaction vessel. One or more reaction vessels may be used in the apparatus for detecting a target analyte according to the present disclosure.

In addition, as used herein, the term “thermal block” may be used as an accommodating body which accommodates one or more reaction vessels formed to fit in a plurality of sample wells formed on the thermal block. According to an embodiment of the present disclosure, the thermal block may be fabricated of a material having excellent thermal conductivity and such. The thermal block may be fabricated of a metal or metal alloy (for example, iron, copper, aluminum, gold, silver, or an alloy containing the same). The thermal block may be machined from a single piece of solid metal, or may be formed by connecting several pieces of metal pieces.

The thermal block of the present disclosure is a thermal block for performing a plurality of reactions. The reaction refers to a chemical, biochemical, or biological transformation involving at least one chemical or biological substance (for example, a solution, a solvent, an enzyme). In the present disclosure, the reaction may preferably be a reaction that is initiated, stopped, promoted or inhibited by a thermal change in the reaction system. For example, the reaction may be a reaction in which decomposition or binding of a biological or chemical substance is carried out according to temperature change, or a reaction in which the activity of an enzyme that performs the production or decomposition of a biological or chemical substance is promoted or inhibited according to temperature change.

Specifically, the reaction may refer to an amplification reaction. The amplification reaction may be a reaction that increases the target analyte (for example, nucleic acid) itself, or may be a reaction that increases or decreases a signal generated depending on the presence of the target analyte. A reaction that increases or decreases a signal generated depending on the presence of the target analyte may or may not be accompanied by an increase in the target analyte. Specifically, the target analyte is a nucleic acid molecule, and the reaction may be a polymerase chain reaction (PCR) or real-time PCR.

In general, the polymerase chain reaction (PCR) is performed by repeating a cycle comprising a reaction including a denaturation step of a nucleic acid, a binding step (hybridization or annealing) of a nucleic acid and a primer, and an extension step of a primer. As used herein, the term “cycle” refers to a unit of condition changes, or a unit of repetition of a condition change, in a plurality of measurements accompanied by the constant condition changes. The constant condition changes, or the repetition of the condition change includes, for example, a change or repetition of the change in temperature, reaction time, number of reactions, concentration, pH, and the number of copies of the measurement object (for example, target nucleic acid molecule). In this case, the constant condition change is an increase in the number of repetitions of the reaction, and the repetition unit of the reaction including the series of steps is set as one cycle.

Various nucleic acid amplification reactions can be performed using the sample heating apparatus of the present disclosure. The reactions are carried out by, for example, polymerase chain reaction (PCR), ligase chain reaction (LCR, see Wiedmann M, et al., “Ligase chain reaction (LCR)—overview and applications.” PCR Methods and Applications 1994 February; 3(4):S51-64), gap filling LCR (GLCR, see WO 90/01069, EP 439162 and WO 93/00447), Q-beta replicase amplification (Q-beta, see Cahill P, et al., Clin Chem., 37(9): 1462-5 (1991), U.S. Pat. No. 5,556,751), strand displacement amplification (SDA, see G Tf Walker et al., Nucleic Acids Res. 20(7):16911696 (1992), EP 497272), nucleic acid sequence-based amplification (NASBA, see Compton, J. Nature 350(6313): 912 (1991)), Transcription-Mediated Amplification (TMA, see Hofmann W P et al., J Clin Virol. 32(4):269-93 (2005); U.S. Pat. No. 5,666,779) or Rolling Circle Amplification (RCA, see Hutchison C. A. et al., Proc. Natl Acad. Sci. USA. 102:1733217336 (2005)).

In particular, the apparatus for detecting a target analyte of the present disclosure is used conveniently for PCR-based nucleic acid amplification reactions. Various nucleic acid amplification methods based on PCR are known. For example, quantitative PCR, digital PCR, asymmetric PCR, reverse transcriptase PCR (RT-PCR), a differential display PCR (DD-PCR), nested PCR, multiplex PCR, SNP genomic typing PCR, and the like are included.

The apparatus for detecting a target analyte according to an embodiment of the present disclosure may be an apparatus for performing a nucleic acid amplification reaction while involving a change in temperature and performing a reaction for generating an optical signal depending on the presence of a nucleic acid, and detecting a generated optical signal.

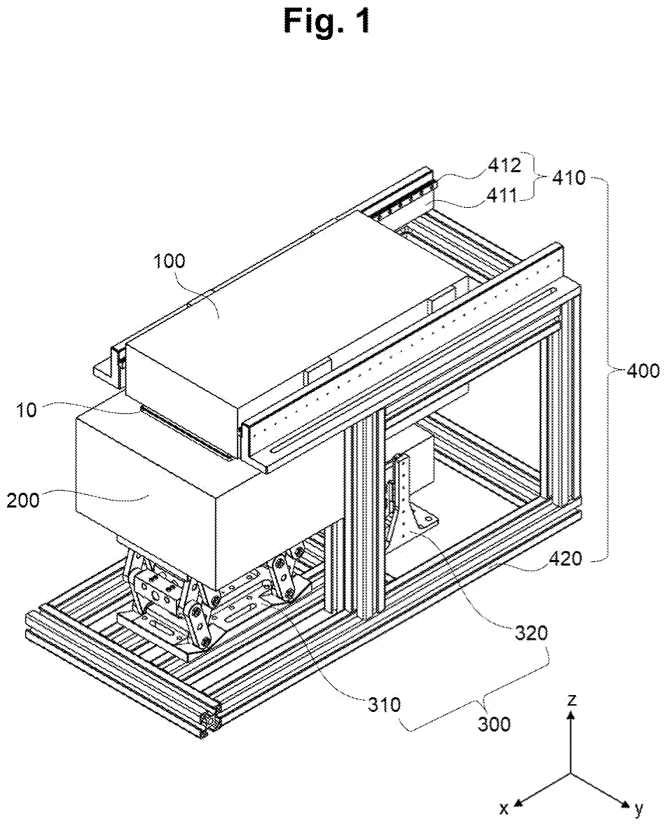

First, referring to FIG. 1, the main configuration of an apparatus for detecting a target analyte according to an embodiment of the present disclosure will be described. FIG. 1 is a perspective view for describing an apparatus for detecting a target analyte, wherein a lifting device 300 is in an elevated state, according to an embodiment of the present disclosure.

As shown in FIG. 1, the apparatus for detecting a target includes a light detection module 100, a thermal module 200, a lifting device 300, and a horizontal moving structure 400. Also as shown in FIG. 1, a reaction vessel 10 can be placed between the light detection module and the thermal module 200. For the sake of convenience, the light detection module 100 and the thermal module 200 are shown simply as boxes. However, it should be understood that the light detection module 100 includes all components needed to irradiate excitation light to the reaction vessel 10 and detect emission light therefrom. Also, it should be understood that the thermal module 100 includes all components needed for thermal cycling for PCR-based amplification reactions.

The light detection module 100 according to an embodiment of the present disclosure may include a light source unit for generating excitation light, and a detection unit for detecting emission light. The excitation light and the emission light may pass through respective filters disposed on a rotary filter wheel. That is, the light detection module 100 may irradiate light to the reaction vessel 10, and detect signals.

The thermal module 200 according to an embodiment of the present disclosure controls the temperature of a reactant in the reaction vessel 10 placed on the thermal module 200, to carry out a nucleic acid reaction. The thermal module 200 may include a thermal block having a plurality of accommodating portions for accommodating the reaction vessel 10, and a thermoelectric element such as a Peltier element, as well as a heat sink, a heat dissipation fan, and other components needed for efficiently heating and cooling the reaction vessel 10 for performing nucleic acid amplification reactions.

The lifting device 300 according to an embodiment of the present disclosure is capable of vertically moving the thermal module 200 to a predetermined height. A reaction vessel 10 may be placed on top of the thermal module 200, and the thermal module 200 may be moved up (the z-axis direction shown in FIGS. 1 to 3) towards the light detection module 100. In an embodiment of the present disclosure, the lifting device 300 may include a height adjusting device 310 for supporting and lifting the weight of the thermal module 200, and a driving unit 320 connected to the height adjusting device 310 for driving the same. The driving unit 320 may include a motor for providing the driving force to the height adjusting device 310.

The horizontal moving structure 400 according to an embodiment of the present disclosure is capable of moving the light detection module 100 in a horizontal direction (the x-axis direction shown in FIGS. 1 to 3). In this case, the light detection module 100 may be moved towards the front of the apparatus (in the +x-axis direction) to cover the top of the thermal module 200, and may be moved towards the rear of the apparatus (in the −x-axis direction) to open the top of the thermal module 200 for placing or removing a reaction vessel 10. The horizontal moving structure 400 may include an upper frame 410 and a lower frame 420. As shown in FIG. 1, the upper frame 410 may include a side wall 411 and a rail 412 fixed to the side wall 411. The light detection module 100 may include a housing with guides mounted on both sides capable of sliding along the rail 412.

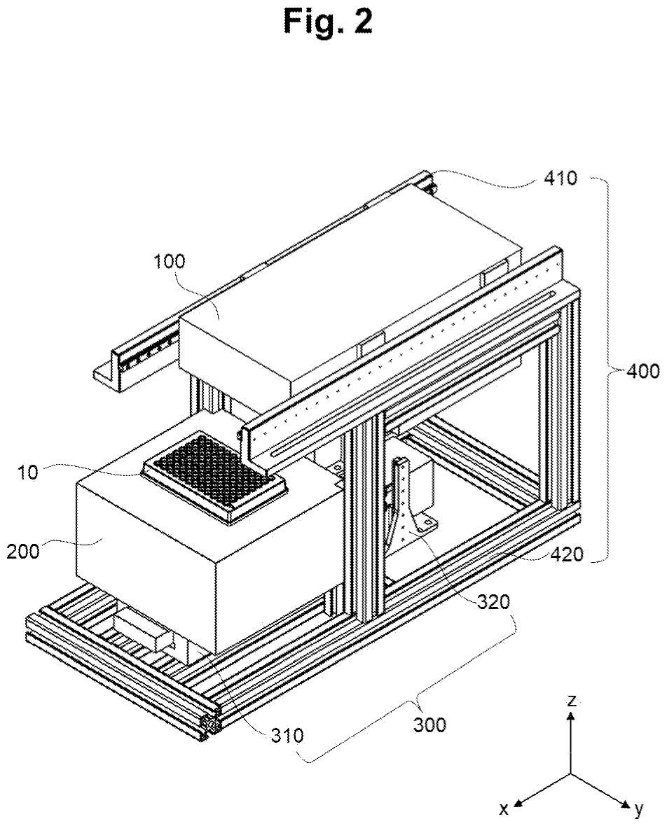

As shown in FIG. 2, thermal module 200 may be lowered by the lifting device 310, and the light detection module 100 may be retracted via the horizontal moving structure 400. FIG. 2 is a perspective view for describing an apparatus for detecting a target analyte, wherein the lifting device 310 is in a lowered state and the thermal module 200 is in an open state, according to an embodiment of the present disclosure.

That is, when the lifting device 310 is in a lowered state and the thermal module 200 is in an open state, the reaction vessel 10 may be easily placed and removed. This allows easy setup for the thermal cycling and signal detection process. According to the present embodiment, since only the lifting device 310 is moved in the z-axis direction, setup is possible with minimal impact on the light detection module 100 and the heating plate 20, which can improve product life as well as misalignment, for more reliable and consistent detection results.

In some embodiments, the horizontal moving structure 400 may be formed such that the lifting device 300 is moved together with the thermal module 200 in a horizontal direction, while the light detection module 100 remains stationary. In this case, components such as the side wall 411 and the rail 412 may be provided on the lower frame 420 of the horizontal moving structure 400. Accordingly, the lifting device 300 may be moved towards the front of the apparatus to allow the top of the thermal module 200 to be open for placing or removing a reaction vessel 10, and may be moved towards the rear of the apparatus to cover the top of the thermal module 200.

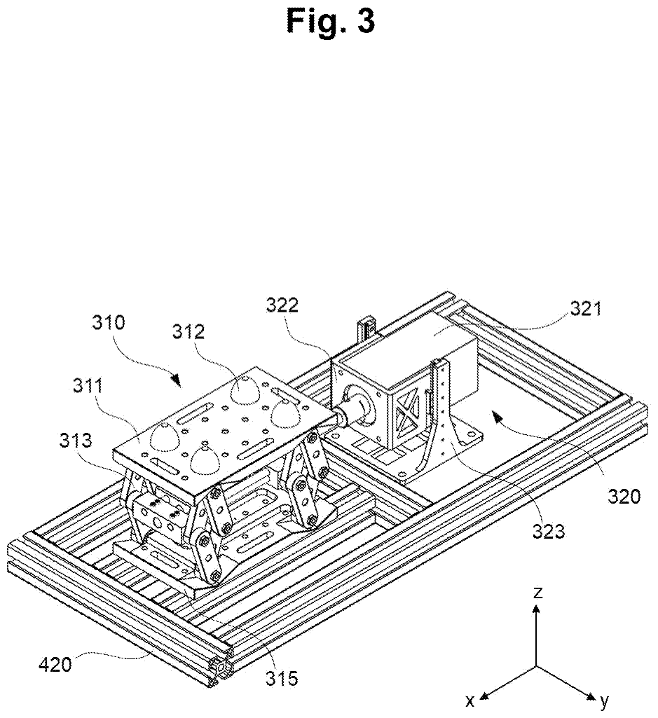

The configuration of an apparatus for detecting a target analyte according to an embodiment of the present disclosure will be further described with reference to FIG. 3. FIG. 3 is a perspective view illustrating a lifting device 300 and a lower frame 420 according to an embodiment of the present disclosure.

As shown in FIG. 3, the height adjusting device 310 of the lifting device 300 may include a platform 311 which forms the upper surface of the height adjusting device 310, and a plurality of compliant bumpers 312 mounted on the platform 311. In an embodiment of the present disclosure, the height adjusting device 310 may use a scissor lift mechanism to vertically move the platform 311. That is, the height adjusting device 310 may include a base 315 which forms the lower surface of the height adjusting device 310, and a plurality of arms 313 may be linked together and disposed between the platform 311 and the base 315, such that the plurality of arms 313 move to adjust the distance therebetween.

In the present disclosure, compliant bumpers 312 may each include a conical portion with a curved sidewall, and the conical portion may at least partially be formed of an elastic material. For example, the conical portion may be formed of a rubber-like material or silicone, or may have a stainless-steel body that is covered by rubber or silicone having a predetermined thickness. In other embodiments of the present disclosure, the compliant bumper 312 may have a different shape and may include a spring as the elastic material. The compliant bumpers 312 may each be mounted and disposed to be spaced apart from each corner of the platform 311 by a predetermined distance. The compliant bumpers 312 are formed so as to evenly distribute force to the thermal module 200, which in turn, can distribute force evenly against the reaction vessel 10 as the lifting device 300 lifts the thermal module 200.

The height adjusting device 310 may be connected to a driving unit 320 which includes a motor 321 for moving the platform 311 up and down. In an embodiment of the present disclosure, the height of the platform 311 may be set with the rotation of the motor shaft of the motor 321.

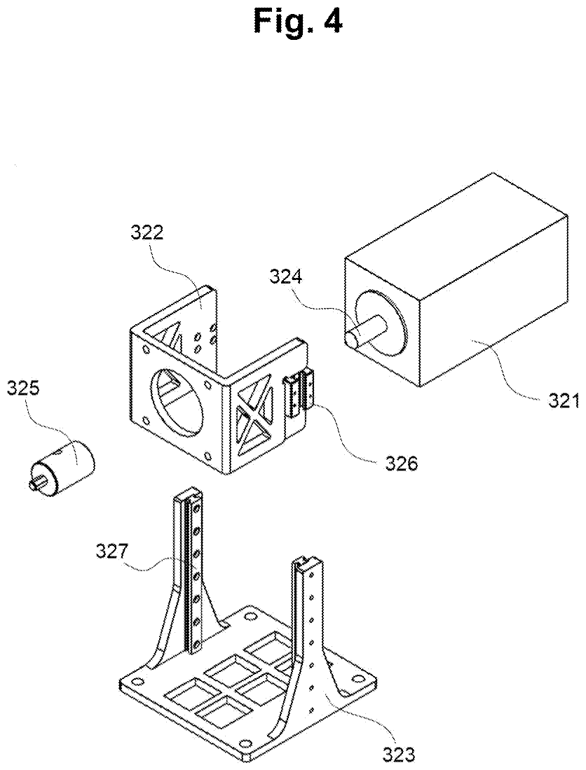

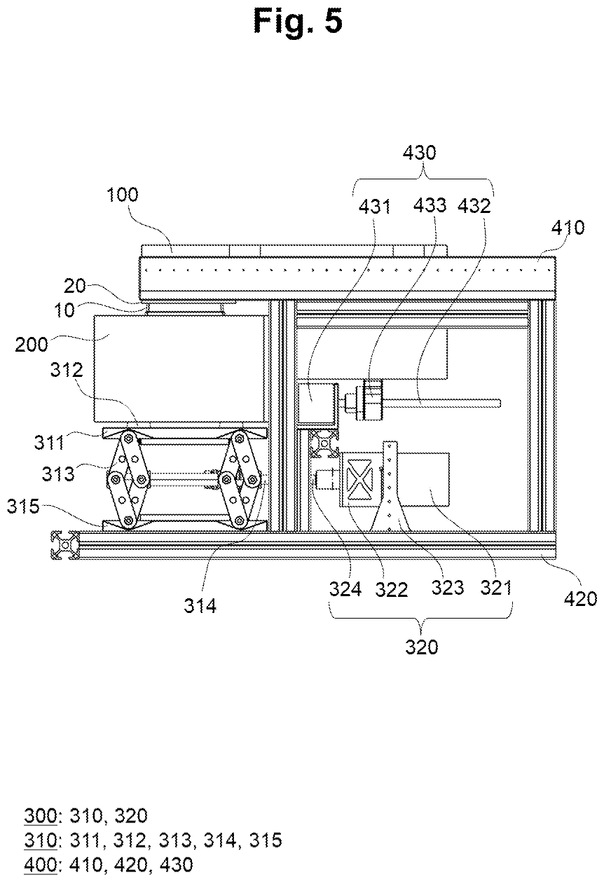

The driving unit 320 may further include a motor frame 322 connected to the motor 321, and a motor mount 323 on which the motor frame 322 can slide up and down. Thus, as the motor 321 drives the height adjusting device 310 to move, the connected portion between the motor 321 and the height adjusting device 310, for example, the rotating shaft 314 (see FIG. 5) and the motor shaft 324 (see FIG. 4), may move accordingly. That is, when the rotating shaft 314 of the height adjusting device 310 moves vertically as the platform 311 and arms 313 move, the motor shaft 324 connected to the rotating shaft 314 may move accordingly, together with the motor 321 and the motor frame 322, along the motor mount 323.

In an embodiment of the present disclosure, the lower frame 420 of the horizontal moving structure 400 may be formed such that the height adjusting device 310 may be fixed thereto. The lower frame 420 shown in FIG. 3 is an exemplary embodiment, and the design is not limited thereto. In the case where the height adjusting device 310 is fixed to the lower frame 420, the height adjusting device 310 is capable of moving the thermal module 200 up and down in a stable manner.

As mentioned previously, in another embodiment of the present disclosure where the horizontal moving structure 400 may be formed such that the lifting device 300 is moved together with the thermal module 200 in a horizontal direction, the lower frame 420 may be configured to have drawer-like characteristics. For example, the lower frame 420 may include a floor portion on which the lifting device 300 is fixed, a sliding guide along which the floor portion slides, and a motor unit that drives the floor portion.

With reference to FIG. 4, a driving unit 320 according to an embodiment of the present disclosure is described in more detail. FIG. 4 is an exploded perspective view for describing the driving unit 320 according to an embodiment of the present disclosure. As mentioned previously, the driving unit 320 may include a motor 321 for moving the platform 311 up and down, a motor frame 322 connected to the motor 321, and a motor mount 323 on which the motor frame 322 can slide up and down. Here, the motor shaft 324 of the motor 321 is connected to the rotating shaft 314 of the height adjusting device 310.

As shown in FIG. 4, the driving unit 320 may further include a motor coupler 325, and the motor shaft 324 may be coupled to the rotating shaft 314 via the motor coupler 325. Due to the motor coupler 325, the connection between the motor shaft 324 and the rotating shaft 314 can be effectively stabilized.

Additionally, according to an embodiment of the present disclosure, the motor mount 323 may be provided with a rail 327, and the motor frame 322 may be provided with a rail guide 326. The rail guide 326 fixed to the motor frame 322 allows the motor 321 to move vertically along the rail 327 of the motor mount 323 in a stable manner.

That is, the rotating shaft 314 and the motor shaft 324 may move vertically as the platform 311 and arms 313 move, and the motor 321 and the motor frame 322 may move likewise, along the rail 327 of the motor mount 323.

With reference to FIG. 5, an apparatus for detecting a target analyte according to an embodiment of the present disclosure. FIG. 5 is a side view for describing an apparatus for detecting a target analyte, wherein the lifting device 300 is in an elevated state, according to an embodiment of the present disclosure.

In FIG. 5, the lifting device 300 is set to an elevated state, where the thermal module 200 is elevated such that the reaction vessel 10 is pressed against a heating plate 20. The heating plate 20 may be provided on a lower portion of the light detection module 100. In this case, as the light detection module 100 moves along the rail 412 of the upper frame 410, the heating plate 20 moves as well. This way, the position and alignment of the heating plate 20 relative to the light detection module 100 can stay consistent.

In some embodiments, the heating plate 20 may be fixed on a portion of the upper frame 410, such that the heating plate 20 does not directly affect the light detection module. In some other embodiments, the heating plate 20 may be fixed on another frame that is spaced apart from the light detection module 100, but is connected to the light detection module 100 such that they move together along the horizontal moving structure 400.

The heating plate 20 may be capable of heating the reaction vessel 10. That is, the heating plate 20 may be used as a heated lid for preventing evaporation or condensation of the samples in the reaction vessel 10.

According to an embodiment of the present disclosure, by providing a lifting device 300 for vertically moving a thermal module 200, the position of the thermal module 200 can be adjusted conveniently. In particular, the lifting device 300 is used to level the thermal module 200 against the heating plate 20, making it possible to perform uniform temperature control of the reaction vessel 10.

As shown in FIG. 5, the reaction vessel 10 may be seated on the thermal module 200, and when the thermal module 200 is moved upward by the lifting device 300, the reaction vessel 10 moves closer to the heating plate 20. On the other hand, when the thermal module 200 is moved downward by the lifting device 300, the reaction vessel 10 moves away from the heating plate 20.

As shown in FIG. 5, the rotating shaft 314 may be coupled to the motor 321 of the driving unit 320 via a motor shaft 324. Thus, according to the rotation of the motor shaft 324 and the rotating shaft 314, the plurality of arms 313 are moved such that the platform 311 and the base 315 are spread apart from each other or pulled close to each other. The direction in which the motor shaft 324 is rotated may determine the increase and decrease in distance between the platform 311 and the base 315, which in turn determines the height position of the thermal module 200.

The horizontal moving structure 400 may include a linear drive unit 430 for driving the light detection module 100 away from the thermal module 200 in a horizontal direction. The light detection module 100 may be mounted in a slidable manner on the upper frame 410 and coupled to a linear motor 431. That is, the light detection module 100 may slide horizontally using the linear motor 431.

More specifically, the linear drive unit 430 may include a linear motor shaft 432 connected to the linear motor 431, and a shaft fixing part 433 into which the linear motor shaft 432 is inserted. The shaft fixing part 433 may be fixed to the bottom of the light detection module 100, and may move horizontally along the linear motor shaft 432 as the linear motor 431 rotates the linear motor shaft 432. The direction in which the light detection module 100 is moves may be determined by the rotational direction of the linear motor 431.

Due to such structure, it is possible for the light detection module 100 and the thermal module 200 to be moved apart from each other horizontally. In some other embodiments, the horizontal moving structure 400 may be configured to move the thermal module 200 and the lifting device 300 horizontally, instead of the light detection module 100. This way, various types of light detection module 100 may be applied to an apparatus for detecting a target analyte according to the present disclosure. For example, in an embodiment of the present disclosure, the light detection module 100 may include a filter wheel to which a plurality of optical fibers is coupled.

In this case, the plurality of optical fibers may be used to transmit light and signals between the light detection module 100 and the reaction vessel 10. Since the light detection module 100 is not configured to move vertically, the optical fibers can be prevented from shifting positions or any undesirable bending. That is, the structure of the apparatus for detecting a target analyte according to the present disclosure is advantageous for having minimal impact on the light detection module 100 as the heating plate 20 is pressed against the reaction vessel 10.

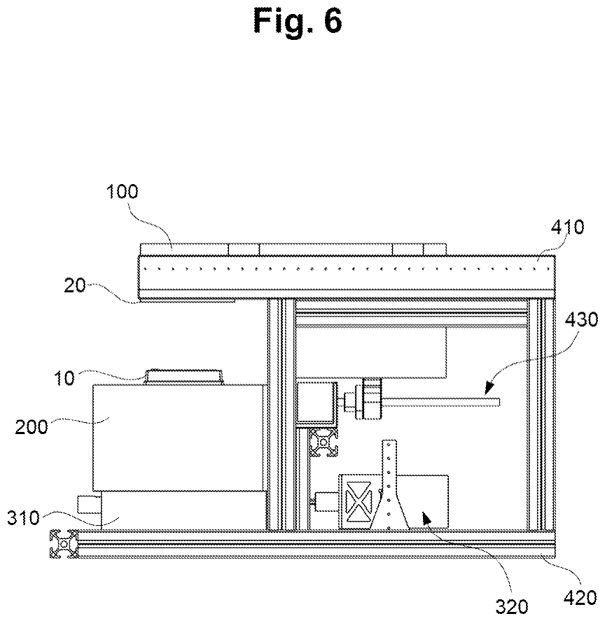

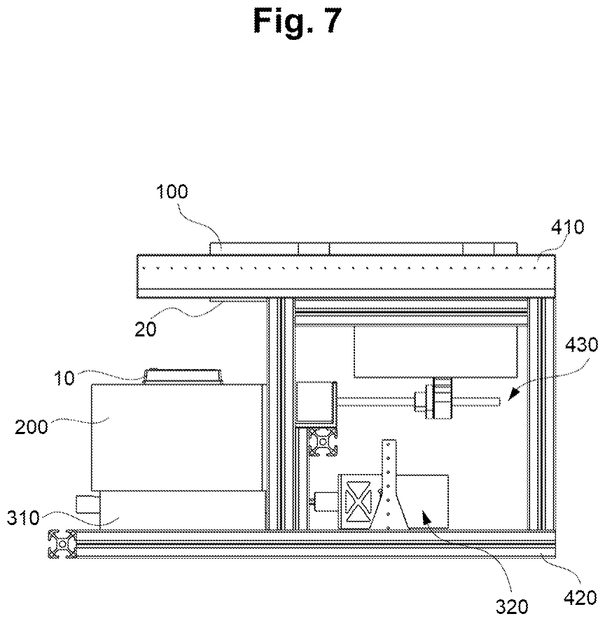

With further reference to FIGS. 6 and 7, the relative movement of the light detection module 100, the thermal module 200 and the lifting device 300 is described. FIG. 6 is a side view for describing an apparatus for detecting a target analyte, wherein the lifting device 300 is in a lowered state and the thermal module 200 is in a closed state, according to an embodiment of the present disclosure. FIG. 7 is a side view for describing an apparatus for detecting a target analyte, wherein the lifting device 300 is in a lowered state and a thermal module 200 is in an open state, according to an embodiment of the present disclosure.

As mentioned previously, the height adjusting device 310 of the lifting device 300 may include a platform 311 which forms the upper surface of the height adjusting device 310, and a plurality of compliant bumpers 312 mounted on the platform 311. However, in FIGS. 6 and 7, the height adjusting device 310 is shown in a simplified manner for the sake of clarity and convenience.

When the thermal module 200 is moved down such that the platform 311 is in a lowered state, as shown in FIG. 6, the vertical distance between the light detection module 100 and the thermal module 200 increases. That is, space is created between the reaction vessel 10 and the heating plate 20. In this state, the light detection module 100 and the thermal module 200 may be movable away from each other in a horizontal direction.

As shown in FIG. 7, after space is created between the reaction vessel 10 and the heating plate 20, the linear drive unit 430 may drive the light detection module 100 towards the rear of the apparatus for detecting a target analyte. That is, the light detection module 100 may be retracted such that the thermal module 200 is in an open state. This way, the reaction vessel 10 can be placed, removed, or replaced easily.

Once a reaction vessel 10 is placed, removed, or replaced, the light detection module 100 may advance back to the state shown in FIG. 6. The thermal module 200 may be lifted by the height adjusting device 310 depending on whether the thermal module 200 is to be used for thermal cycling or not. When the samples contained in the reaction vessel 10 placed on the thermal module 200 are subject to thermal cycling, the height adjusting device 310 may lift the thermal module 200 to the state shown in FIG. 5.

According to the present disclosure as described above, it is possible to increase the efficiency of the nucleic acid amplification reaction and the performance of an apparatus for detecting a target analyte, by minimizing the difference between the temperature change rate and the temperature maintenance range between samples contained within a reaction vessel such as a reaction vessel 10.

What is claimed is:

1. An apparatus for detecting a target analyte comprising:
a light detection module that irradiates light to a reaction vessel and detects signals;
a thermal module for heating and cooling the reaction vessel; and
a lifting device for vertically moving the thermal module.

2. The apparatus of claim 1, wherein the lifting device comprises a height adjusting device for supporting the thermal module, and a motor for providing a driving force to the height adjusting device.

3. The apparatus of claim 2, wherein the height adjusting device comprises a platform configuring an upper surface of the height adjusting device, and a plurality of compliant bumpers mounted on the platform.

4. The apparatus of claim 3, wherein the compliant bumpers each comprise a conical portion with a curved sidewall, and the conical portion is at least partially formed of an elastic material.

5. The apparatus of claim 3, wherein the compliant bumpers are each mounted and disposed to be spaced apart from each corner of the platform by a predetermined distance.

6. The apparatus of claim 2, wherein the height adjusting device uses a scissor lift mechanism to vertically move the platform.

7. The apparatus of claim 5, wherein the height adjusting device comprises a rotating shaft, and the rotating shaft is coupled to the motor and rotated by the motor.

8. The apparatus of claim 2, wherein the apparatus further comprises: a motor frame that encloses at least a portion of the motor, and a motor mount to which the motor frame is vertically slidably coupled.

9. The apparatus of claim 1, wherein a heating plate is provided on a lower portion of the light detection module.

10. The apparatus of claim 9, wherein the reaction vessel is seated on the thermal module, and
when the thermal module is moved upward by the lifting device, the reaction vessel moves closer to the heating plate, and
when the thermal module is moved downward by the lifting device, the reaction vessel moves away from the heating plate.

11. The apparatus of claim 10, wherein when the thermal module moves downward, the light detection module and the thermal module are movable away from each other in a horizontal direction.

12. The apparatus of claim 10, wherein the light detection module is mounted in a slidable manner on an upper frame.

13. The apparatus of claim 12, wherein the light detection module is coupled to a linear motor, and the light detection module slides horizontally using the linear motor.

14. The apparatus of claim 1, wherein the light detection module comprises a filter wheel to which a plurality of optical fibers is coupled.

15. The apparatus of claim 14, wherein the plurality of optical fibers is used to transmit light and signals between the light detection module and the reaction vessel.
